(19) United States
(12) Patent Application Publication
(10) Pub. No.: US 2026/0198469 A1
(43) Pub. Date: Jul. 16, 2026

(54) FISH GRABBER

(71) Applicant: AOB Products Company, Columbia, MO (US)

(72) Inventors: Dennis W. Cauley, Jr., Fayette, MO (US); Timothy S. Kinney, Warrenton, MO (US); Matthew Kinamore, Columbia, MO (US); James Tayon, Moberly, MO (US); Mark Dalton, Columbia, MO (US); Russell Bergeron, Columbia, MO (US); Chad Glascock, Columbia, MO (US); Todd Strobel, Columbia, MO (US); Cale Johanning, Columbia, MO (US)

(73) Assignee: AOB Products Company, Columbia, MO (US)

(21) Appl. No.: 19/446,386

(22) Filed: Jan. 12, 2026

Related U.S. Application Data
(60) Provisional application No. 63/743,832, filed on Jan. 10, 2025.

(51) Int. Cl. A01K 97/00; G01G 19/60

(52) U.S. Cl. CPC A01K 97/00; G01G 19/60

(57) ABSTRACT

An object grabber for grabbing an object. The object grabber includes a first handle that can be grasped by a hand of a user and a second handle that can be grasped by the hand of the user. An object holder is moveable between a release configuration to release the object and a grabbing configuration to grab the object. An actuator is operatively connected to the object holder to move the object holder between the release and grabbing configurations. A scale indicates a weight of the object held by the object holder.

### CROSS-REFERENCE TO RELATED APPLICATION

The present application claims priority to U.S. Provisional Patent Application No. 63/743,832, filed Jan. 10, 2025, the entirety of which is hereby incorporated by reference.

### FIELD

The present disclosure generally relates to equipment for grabbing and weighing an object or item, and more particularly to an object grabber for grabbing, holding, and weighing an object, such as a fish.

### BACKGROUND

Fishermen can use various tools and devices to safely handle and control fish during catch and release activities or when preparing fish for storage. Fishermen may use a weighing device to determine the weight of a fish.

### SUMMARY

In one aspect, an object grabber for grabbing an object comprises a first handle configured to be grasped by a hand of a user. A second handle is configured to be grasped by the hand of the user. An object holder is moveable between a release configuration to release the object and a grabbing configuration to grab the object. An actuator is operatively connected to the object holder to move the object holder between the release and grabbing configurations. A scale is configured to indicate a weight of the object held by the object holder.

Other objects and features of the present disclosure will be in part apparent and in part pointed out herein.

### BRIEF DESCRIPTION OF FIGURES

FIG. 1 is a perspective of an object grabber according to one embodiment of the present disclosure, an object holder of the object grabber being in a grabbing configuration and a scale of the object grabber indicating no weight;

FIG. 2 is another perspective of the object grabber, the object holder being in a release configuration;

FIG. 3 is a cross-sectional view of the object grabber with the object holder in the grabbing configuration and the scale indicating no weight;

FIG. 4 is another cross-sectional view of the object grabber with the object holder in the grabbing configuration and the scale indicating no weight;

FIG. 5 is similar to FIG. 3, but the object holder is in a release configuration;

FIG. 6 is a side elevation of the object grabber with the object holder in the grabbing configuration and the scale indicating a weight;

FIG. 7 is a cross-sectional view of the object grabber with the object holder in the grabbing configuration and the scale indicating a weight;

FIG. 8 is another cross-sectional view of the object grabber with the object holder in the grabbing configuration and the scale indicating a weight; and

FIG. 9 is an exploded view of the object grabber.

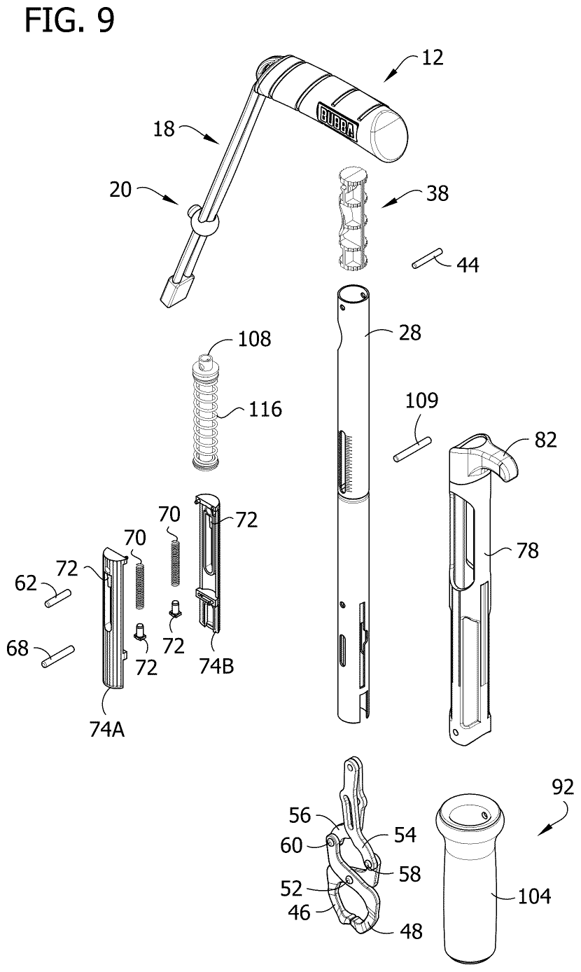

Corresponding reference numbers indicate corresponding parts throughout the drawings.

### DETAILED DESCRIPTION

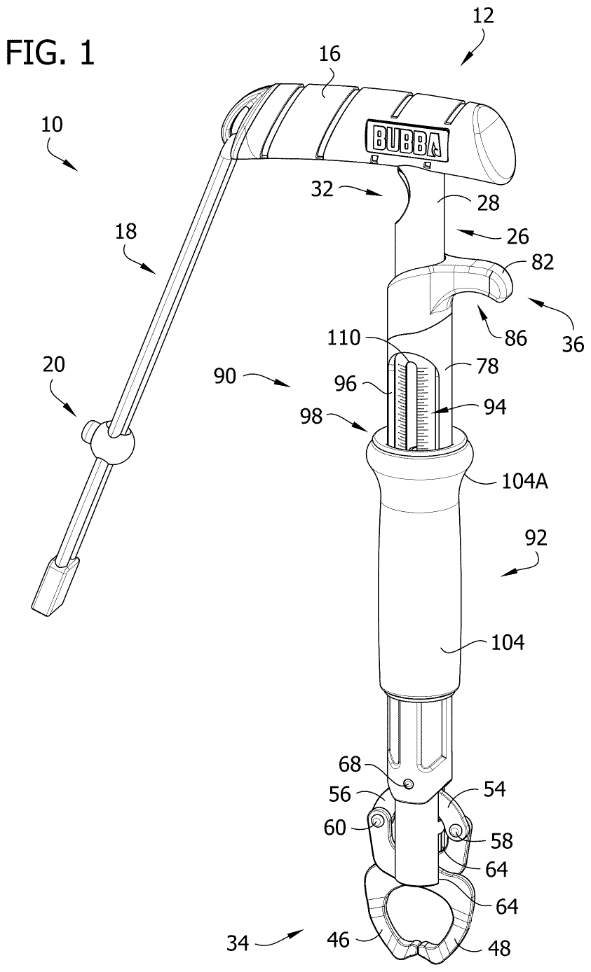

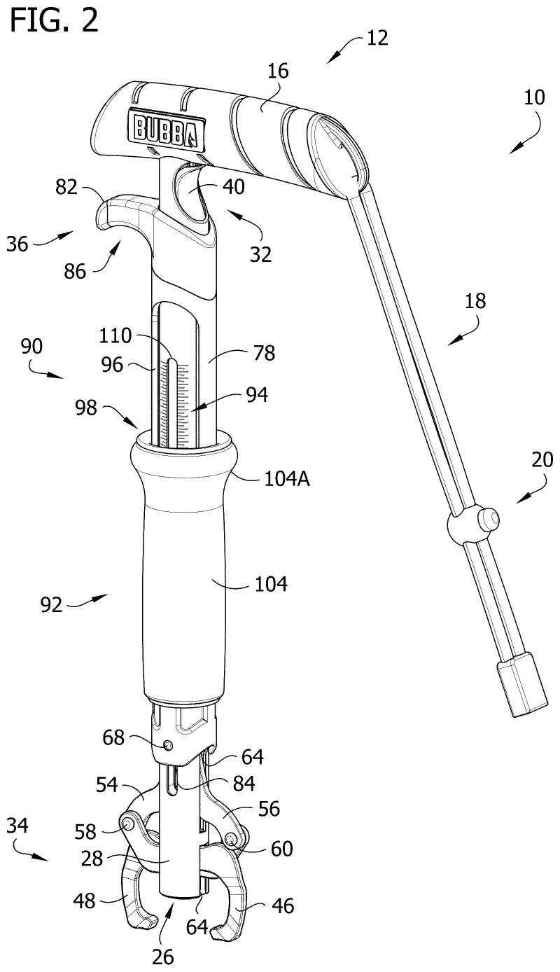

Referring to FIGS. 1 and 2, one embodiment of an object grabber according to the present disclosure is generally indicated by reference numeral 10. The object grabber 10 is able to selectively grab and release an object or item, such as a fish. The object grabber 10 can be considered a fish grabber or lip grabber (e.g., fish lip grabber) for grabbing and holding a fish, typically by the mouth. It is understood the object grabber 10 of the present disclosure can be used to grab other objects or items, besides a fish, without departing from the scope of the present disclosure.

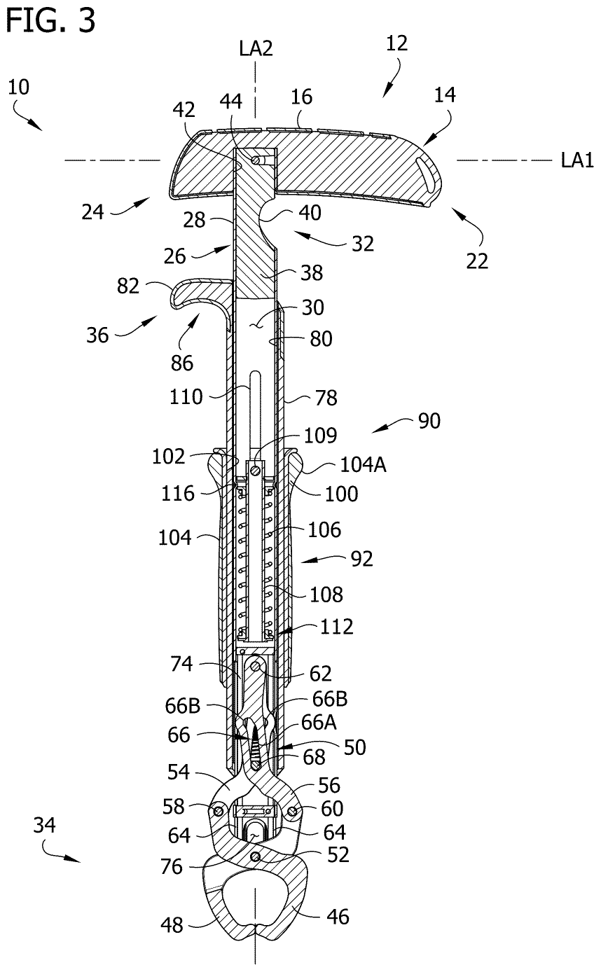

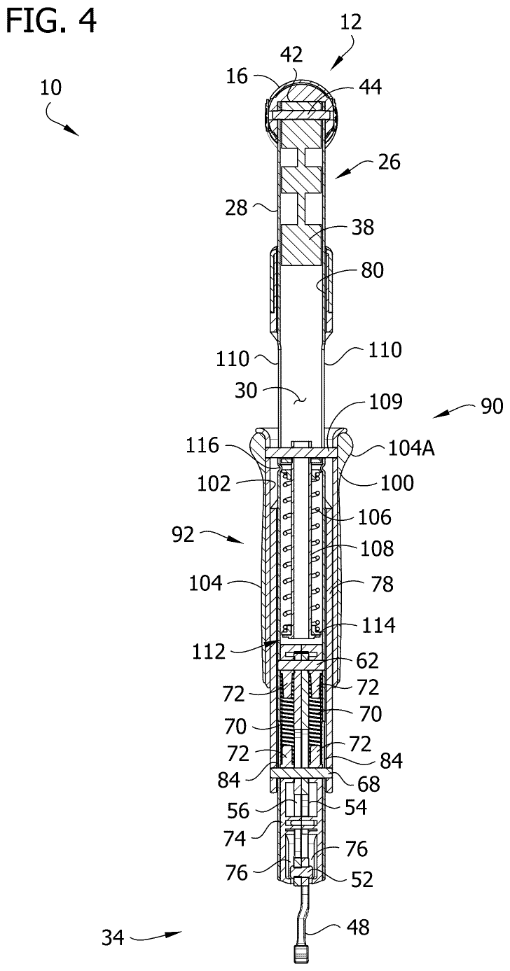

Referring to FIGS. 1-4, the object grabber 10 includes a first or palm handle 12 configured to be grasped by a hand of a user or operator. In the illustrated embodiment, the first handle 12 comprises a handle body 14 with a gripping material 16 overlying at least a portion of the handle body. The gripping material 16 forms a grip for the first handle 12 to enable the user to better grasp the first handle. The gripping material 16 can be any suitable material which enhances the user's grip with the first handle, such as a polymer (e.g., an elastomer such that the gripping material is an elastomeric material). The gripping material 16 can be overmolded on the handle body 14. In one embodiment, the gripping material 16 and/or exposed surface portions of the handle body 14 have a textured surface (e.g., ridges, bumps, recesses, depressions, and the like) for enhancing grip. In the illustrated embodiment, the first handle 12 has an ergonomic palm swell (formed by the handle body 14 and gripping material 16) configuration that provides a natural gripping surface and conforms to the user's hand during operation. This enhances grip security and user comfort during use of the object grabber 10. The palm swell configuration includes the top of the first handle 12 being slightly curved (see FIGS. 3 and 4) to better conform to the palm of the hand of the user when the hand is grasping the first handle. The palm swell configuration also includes the first handle 12 having a sufficient thicknesses (e.g., diameter) to sufficiently fill the a void in the palm of the hand of the user when the hand (e.g., fingers thereof) wrap around the first handle. The hand of the user grasps the first handle 12 by engaging the palm with the first handle (e.g., the top side thereof) and wrapping the fingers around the first handle. The first handle 12 includes opposite first and second (e.g., left and right) ends 22, 24 and a longitudinal axis LA1 (e.g., gripping axis) extending between the first and second ends. Other configurations can be used without departing from the scope of the present disclosure.

The object grabber 10 can include a tether or cord 18 connected to the first handle 12. In the illustrated embodiment, the first handle 12 (specifically, the handle body 14) has an opening or aperture through which the tether 18 extends. The tether 18 forms a loop to be worn around the wrist of the user. The tether 18 can include a tether or cord lock 20 for securing the tether 18 on the wrist of the user.

The object grabber 10 includes a support 26, an actuator 36, and an object holder 34. The object holder 34 selectively grabs and holds the object. The actuator 36 is operated or actuated by the user to selectively grab and release the object with the object holder.

The support 26 is connected to the first handle 12. The support 26 extends from the first handle 12. The support 26 extends from the first handle 12 in a direction that is transverse to the longitudinal axis LA1 of the first handle. In the illustrated embodiment, the direction (e.g., downward) the support 26 extends from the first handle 12 is generally perpendicular to the longitudinal axis LA1 of the first handle. Thus, the first handle 12 and the support 26 are oriented generally perpendicular to one another. A longitudinal axis LA2 of the support 26 is oriented generally perpendicular to the longitudinal axis LA1 of the first handle 12. In the illustrated embodiment, the support 26 is generally in the form of a rod or shaft, although other configurations can be used without departing from the scope disclosure. The support 26 includes a main tube or body 28 (support tube or body) defining an interior 30. The interior 30 is open at the opposite ends (e.g., upper and lower ends) of the main tube 28. The main tube 28 can be made of any suitable material, such as metal (e.g., stainless steel). Other configurations can be used without departing from the scope of the present disclosure.

The support 26 (broadly, the object grabber 10) has a recess or cutout 32 sized, shaped, and arranged to receive the hand (e.g., a portion thereof) of the user when the hand is grasping the first handle 12. In the illustrated embodiment, the recess 32 is sized, shaped, and arranged to receive a middle finger (e.g., a portion thereof) of the hand when the hand is grasping the first handle 12 and the middle finger wraps around the first handle. The recess 32 is adjacent to the first handle 12, positioned just below the first handle 12 along the main tube 28. The recess 32 in the support 26 allows the user to position their hand closer toward the second end 24 of the first handle 12 than if the support did not have the recess. This allows the user to better align their hand gripping the first handle 12 with the actuator 36 to position a finger (e.g., index finger) to actuate (e.g., grab and pull) the actuator to operate the object holder 34. This greatly increases grip control and user experience. The recess 32 also allows the user to position the finger (e.g., index finger) closer to the center of the support 26 (e.g., main tube 28), which transfers the weight of the object held by the object holder 34 to the first handle 12. This enhances the overall ergonomics by reducing the offset of the user's hand from the center of the support 26, reducing a moment force (due to the weight of the object) resisted by the user's hand grasping the first handle, enabling the user to have better control of the object grabber 10. The user can grip the first handle 12 with their palm along the top of the first handle and can wrap the fingers (specifically, the middle finger, the ring finger, and the pinky finger) of the hand around and under the first handle, with the middle finger located in the recess 32. This locates the index finger of the hand to selectively engage the actuator 36 to operate the object holder 34. It is appreciated the configuration of the first handle 12 also allows the index finger to wrap around and under the first handle 12 when not engaging the actuator 36 to further enhance the user's grip on the first handle. In the illustrated embodiment, the base of the recess 32 is curved. Other configurations can be used without departing from the scope of the present disclosure.

The main tube 28 of the support 26 borders (broadly, defines) the recess 32 (at least a portion thereof). In the illustrated embodiment, the a portion of the main tube 28 is removed to form the recess 32. The support 26 includes a brace or stiffener 38 structurally reinforcing the main tube 28 at the recess 32. The brace 38 borders the recess 32 and reinforces the structural integrity of the main tube 28 at the location where the recess 32 is formed. The brace 38 borders (broadly, defines) the recess (at least a portion thereof). The brace 38 is exposed to the user for the purpose of engaging and supporting the finger (e.g., middle finger) disposed in the recess 32. The brace 38 includes a smooth, curved surface 40 which generally defines the base the of the recess 32. The brace 38 is disposed within the interior 30 of the main tube 28. The brace 38 can be made of plastic, metal, or any other suitable material.

The brace 38 includes an upper or first section disposed in a portion of the interior 30 above the recess 32, a lower or second section disposed in the portion of the interior below the recess, and a third or intermediate section (including the surface 40) disposed in the portion of the interior aligned with the recess. As illustrated, the brace 38, specifically each section thereof, generally fills up the interior 30 of the main tube 28. The brace 38 can include one or more ribs or walls which conform to the shape of the interior 30, to provide a snug fit between the brace (specifically, each section thereof) and the main tube 28.

The support 26 is fixed to the first handle 12. In the illustrated embodiment, the first handle 12 includes a cavity or blind bore 42 which receives the first or upper end of the support 26. The main tube 28 and the brace 38 (e.g., upper ends thereof) are disposed in the cavity 42. A pin or shaft 44 (broadly, connector) connects the support 26 to the first handle 12. The pin 44 extends through the brace 38, through the main tube 28, and into the handle body 14 (e.g., into each side of the handle body). Other configurations (e.g., ways of connecting the first handle and the support) can be used without departing from the scope of the present disclosure.

The support 26 is arranged to extend between two fingers (specifically, the index finger and the middle finger) of the hand of the user when the hand is grasping the first handle 12. The recess 32 provides further comfort to the user by providing finger relief. The recess 32 allows the support 26 to better fit between two fingers (specifically, the index finger and the middle finger) of the user by reducing the spreading between the two fingers while the user grasps the first handle 12 and operates the actuator 36. The support 26 is spaced apart from both the first and second ends 22, 24 of the first handle. Desirably, as shown in the illustrated embodiment, there is enough space along the first handle 12 between the first end 22 and the support 26 and between the second end 24 and the support for at least one finger to be able to wrap around the first handle to grasp the first handle. In the illustrated embodiment, the first handle 12 has a first portion between the support 12 and the first end 22 of sufficient length to allow the middle finger, the ring finger, and the pinky finger to wrap around and grasp the first portion of the first handle. The first handle 12 also has a second portion between the support 12 and the second end 24 of sufficient length to allow the index finger to wrap around and grasp the second portion of the first handle. Other configurations can be used without departing from the scope of the present disclosure.

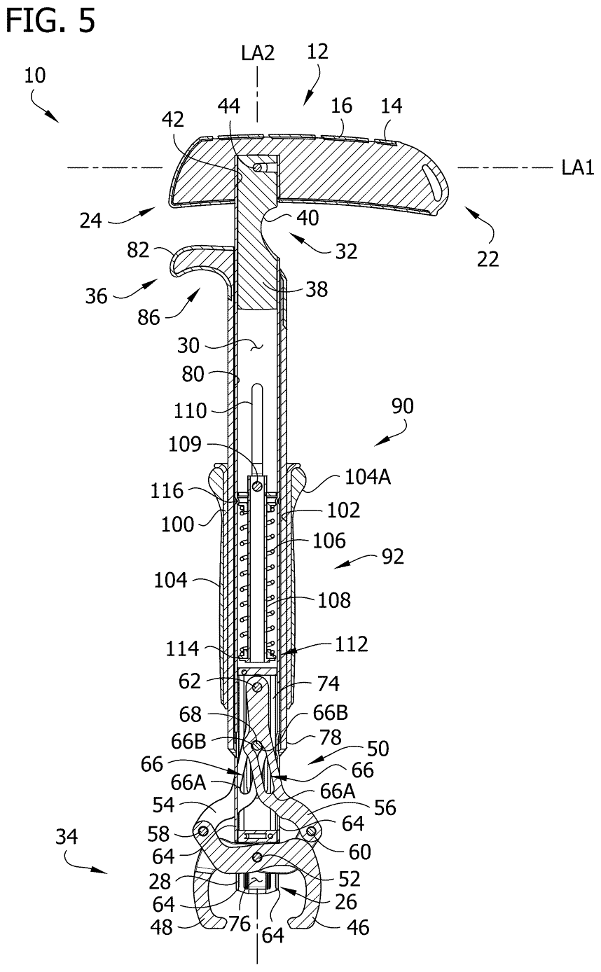

Referring to FIGS. 1-5, the object holder 34 is disposed at the end (e.g., lower end) of the support 26 opposite the first handle 12. The support 26 extends between the first handle 12 and the object holder 34. The object holder 34 is supported by (e.g., connected to) the support 26. More generally, the object holder 34 is supported by the first handle 12. The first handle 12 can be considered to support any other component of the object grabber 10. In general, the object holder 34 is selectively openable and closeable to releasably grab the object or item. The object holder 34 is moveable between or arrangeable in a first, closed, or grabbing configuration (FIGS. 1, 3, 4, and 6-8) to grab the object and a second, open, or release configuration (FIGS. 2 and 5) to release the object. In the illustrated embodiment, the object holder 34 is configured to grab a fish, such as by the lip of the fish, although the object holder can grab other objects or items without departing from the scope of the present disclosure.

In the illustrated embodiment, the object holder 34 comprises first and second jaws 46, 48. At least one of the first or second jaw 46, 48 is configured to pivot relative to the other of the first or second jaw when the object holder 34 is moved between the release and grabbing configurations. In other words, in some embodiments, one of the jaws 46, 48 can be fixed or stationary and the other jaw is moveable. Or, in some embodiments, both jaws 46, 48 are moveable. In the illustrated embodiment, both the first and second jaws 46, 48 move (e.g., pivot) relative to one another between the release and grabbing configurations. The first and second jaws 46, 48 are generally identical (e.g., mirror images of one another) and each include a tip with a curved gripping surface to engage and securely hold an object, such as a fish lip. It is understood the tip or gripping section of the jaws can have other configurations, such as for other kinds of objects, without departing from the scope of the present disclosure. The jaws 46, 48 are positioned to define an opening therebetween when in the release configuration, allowing an object to be inserted between the jaws. When moved toward the grabbing configuration, the jaws 46, 48 pivot toward one another to close the opening and securely grip the object therebetween. In the illustrated embodiment, in the grabbing configuration, with no object between the jaws 46, 48, the tips or gripping surfaces of the jaws engage one another. In other embodiments, the tips or gripping surfaces of the jaws can be spaced apart from one another when the jaws are in the grabbing configuration, with no object therebetween. In the case of grabbing a lip of a fish, the lip of a fish is typically very thin such that the jaws 46, 48 will nearly be in the grabbing configuration when squeezing the lip of the fish therebetween. Each jaw 46, 48 moves (e.g., pivots) between a respective first, closed, or grabbing position (FIGS. 1, 3, 4, and 6-8) and a second, open, or release position (FIGS. 2 and 5). Both jaws 46, 48 are in their respective grabbing positions when the object holder 34 is in the grabbing configuration, and both jaws are in their respective release positions when the object holder is in the release configuration.

Referring to FIGS. 3-5, the first and second jaws 46, 48 generally have an S-shape and crossover one another. At the crossover point, the first and second jaws 46, 48 are connected by a first pivot connection 52. The object holder 34 includes a driver 50 that facilitates or drives the movement of the first and second jaws 46, 48 between the grabbing and release configurations. The driver 50 pivots the first and second jaws 46, 48 about the first pivot connection 52. The driver 50 includes a first jaw driver or link 54 and a second jaw driver or link 56. The first and second jaw drivers 54, 56 are generally identical (e.g., are mirror images of one another). The first jaw driver 54 is connected to the first jaw 46 by a second pivot connection 58. Likewise, the second jaw driver 56 is connected to the second jaw 48 by a third pivot connection 60. The second and third pivot connections 58, 60 are each disposed at an end of their respective jaw 46, 48 opposite the tip. The second and third pivot connections 58, 60 are also each disposed at an end of their respective jaw driver 54, 56. The first and second jaw drivers 54, 56 are connected by a fourth pivot connection 62. The fourth pivot connection 62 is disposed at the end of each jaw driver 54, 56 opposite the respective second and third pivot connections 58, 60. In the illustrated embodiment, each pivot connection 52, 58, 60, 62 is formed by a shaft or fastener, such as a bolt or rivet, although other ways of forming the pivot connection can be used without departing from the scope of the present disclosure.

Each jaw driver 54, 56 includes a first elongate segment disposed within the interior 30 of the support 26 and a second segment that extends from an end of the first segment and out of the interior 30 through a side of the support 26. The support 26 (e.g., main tube 28) includes openings 64 (e.g., slots) to permit the jaws 46, 48 and jaw drivers 54, 56 to extend out of the interior 30. The openings 64 provide sufficient clearance to permit the jaws 46, 48 and jaw drivers 54, 56 to move therein as object holder 34 moves between the grabbing and release configurations. Each jaw driver 54, 56 includes a slot or track 66. The slot 66 is disposed in the first elongate segment. In the illustrated embodiment, each slot 66 includes a first linear segment 66A and a second linear segment 66B extending at an angle from an end (e.g., upper end) of the first segment. A driving pin or shaft 68 (broadly, driving member) extends through both slots 66 of each jaw driver 54, 56. The driving pin 68 moves (e.g., slides) along the slots 66 and movement of the driving pin 68 moves the object holder 34 between the grabbing and release positions, as described in more detail below. In the grabbing configuration (FIG. 3), the driving pin 68 is positioned at one end (e.g., lower end) of each slot 66 (the end formed by the first segment 66A). This is the first, closed, or grabbing position of the driving pin 68. In the release configuration (FIG. 5), the driving pin 68 is positioned at the opposite end (e.g., upper end) of each slot 66 (the end formed by the second segment 66B). This is the second, open, or release position of the driving pin 68.

Still referring to FIGS. 3 and 4, the object holder 34 is biased toward the grabbing configuration. The object grabber 10 includes at least one closing spring 70 biasing the object holder 34 (e.g., the jaws 46, 48 and the driver 50) toward the grabbing configuration. In the illustrated embodiment, the object grabber 10 includes two closing springs 70. The closing springs 70 are disposed within the interior 30 of the support 26. The closing springs 70 are arranged to push the driving pin 68 toward its grabbing position. In the illustrated embodiment, spring guides 72 at each end of the closing springs 70 extend into each closing spring. The upper spring guides 72 connect the closing springs 70 to the shaft or fastener forming the fourth pivot connection 62 and the lower spring guides connect the closing springs to the driving pin 68. The two closing springs 70 are disposed on opposite sides of the jaw drivers 54, 56 to provide a uniform force to the driving pin 68. The closing springs 70 apply biasing force that urges the object holder 34 toward the grabbing configuration, ensuring that the first and second jaws 46, 48 remain closed around an object unless actively opened by the user through operation of the actuator 36. The closing springs 70 provide consistent closing force and enables automatic closure of the jaws 46, 48 when the actuator 36 is released by the user.

The support 26 spaces the first handle 12 from the object holder 34. This keeps the user's hand a safe distance from the object holder 34 and the object held thereby. For example, when the object is a fish, the user's hand is positioned a safe distance from any sharp teeth of the fish.

The object holder 34 is connected to the lower end of the main tube 28 of the support 26. In the illustrated embodiment, the object grabber 10 includes a sub-housing or insert 74 that contains, connects to, and supports various components of the object grabber 10, such as components of the object holder 34. The insert 74 is has a generally cylindrical exterior shape and is disposed in the interior 30 of the support 26. During assembly, the insert 74 is inserted upward into the interior 30 through the open lower end of the interior (e.g., open lower end of the main tube 28). In the illustrated embodiment, the shaft or fastener forming the fourth pivot connection 62 is attached to the insert 74, with the remaining components of the driver 50 and the first and second jaw 46, 48 being suspended therefrom. The insert 74 can have guide channels 76 into which the respective ends of the shaft or fastener forming the first pivot connection 52 extend to guide movement of the shaft or fastener, as described in more detail below. The insert 74 has openings (e.g., slots) aligned with the openings 64 of the support 26 to permit components to extend out of the insert and out of the interior 30. Other configurations (e.g., ways of connecting the object holder 34 to the support 26) can be used without departing from the scope of the present disclosure.

The object holder can have other configurations without departing from the scope of the present disclosure.

Referring to FIGS. 1-5, the actuator 36 is operatively connected to the object holder 34 to move the object holder between the release and grabbing configurations. The actuator 36 is operated or actuated by the user to selectively move the object holder 34 between the grabbing and release configurations. The object grabber 10 includes an actuator support, mount, or tube 78. The actuator 36 is attached (e.g., fixed) to the actuator tube 78 such that the actuator and actuator tube move together. The actuator 36 and the actuator tube 78 move relative to the support 26. Specifically, the actuator tube 78 slides linearly along the longitudinal axis LA2 of the support 26. The actuator tube 78 slides longitudinally upward and downward along the main tube 28. The actuator tube 78 is disposed over the support 26 (e.g., main tube 28), with the support positioned within a bore or interior 80 of the actuator tube. The support 26 extends through the interior 80 of the actuator tube 78, out the upper and lower ends thereof. The actuator tube 78 moves longitudinally relative to the support 26 to operate the object holder 34. The actuator tube 78 can be made of metal, plastic, polymer, and/or any other suitable materials.

The actuator 36 is arranged relative to the first handle 12 to be actuated by the hand of the user when the hand is grasping the first handle. In particular, the actuator 36 is arranged relative to the first handle 12 to be actuated by a finger (specifically, the index finger) of the hand of the user when the hand is grasping the first handle. For the purposes of this disclosure (including the claims), a thumb is not considered to be a finger. The actuator 36 is moveable relative to the first handle 12 (and the second handle 92 described in more detail below). The actuator 36 is moveable between a first, closed, or grabbing position (FIG. 1) and a second, open, or release position (FIG. 2). The actuator 36 is within reach of the user's finger (e.g., index finger) when the actuator is in the grabbing position (and the release position) and the user's hand is grasping the first handle 12. In the illustrated embodiment, the actuator 36 is disposed on a side of the support 26 opposite the recess 32. The ergonomic positioning of the actuator 36 relative to the first handle 12 makes the actuator readily accessible to the user when grasping the first handle.

In the illustrated embodiment, the actuator 36 is configured to only be actuated (e.g., pushed, pulled, pressed, released, etc.) by a single finger of the hand of the user when the hand is grasping the first handle 12. In the illustrated embodiment, the single finger is the index finger. The actuator 36 is configured to only be engaged by the single finger of the hand of the user when the hand is grasping the first handle 12. The support 26, the first handle 12, and the actuator 36 are arranged relative to one another such that the support blocks other fingers (e.g., middle finger, ring finger, and pinky) of the hand of the user from contacting the actuator. When grasping the first handle 12, (1) the support 26 extends between the middle and index fingers, (2) the middle, ring, and pinky fingers of hand are disposed on the same side of the support as the recess (with the middle finger in the recess) and grasp the first portion of the first handle 12, and (3) the index finger of the hand is disposed on the same side of the support as the actuator and can selectively operate the actuator as desired. This arrangement ensures that the user maintains a strong or firm grip on the first handle 12 with the middle, ring, and pinky fingers while operating the actuator 36 with the index finger to open and close the object holder 34. This enables the user to easily actuate the object holder 34 while maintaining complete control of the first handle 12 (broadly, while maintaining complete control of the object grabber 10, and thereby the object being held by the object holder 34). Other configurations can be used without departing from the scope of the present disclosure.

In the illustrated embodiment, the actuator 36 comprises a trigger 82, although other configurations of the actuator (e.g., button, knob, lever, etc.) can be used without departing from the scope of the present disclosure. The trigger 82 is arranged relative to the first handle 12 to be actuated by the single finger (e.g., index finger) of the hand of the user when the hand is grasping the first handle. The trigger 82 can include a finger recess 86 (e.g., a single finger recess) opposite the first handle 12 and sized and shaped to receive the single finger. The trigger 82 can include gripping material (similar to the first handle 12) forming at least a portion of the exterior of the trigger to enable to the user to better grasp the trigger. The gripping material of the trigger can be any suitable material which enhances the user's grip with the trigger, such as a polymer (e.g., an elastomer such that the gripping material is an elastomeric material). The gripping material can be overmolded on a trigger body and can also be overmolded on at least a portion of the actuator tube 78. In one embodiment, the gripping material of the trigger has a textured surface (e.g., ridges, bumps, recesses, depressions, and the like) for enhancing grip. This construction creates an ergonomic gripping surface for the trigger that conforms to the user's finger and provides enhanced control during operation. Other configurations can be used without departing from the scope of the present disclosure.

The actuator 36 (e.g., trigger 82) moves linearly to move the object holder 34 between the release and grabbing configurations. The actuator 36 slides with the actuator tube 78 relative to the support 26, along the longitudinal axis LA2, when actuated (e.g., pulled, released) by the user. The actuator tube 78 is connected to the object holder 34 via the driving pin 68. The lower end portion of the actuator tube 78 is attached to the driving pin 68. The driving pin 68 moves with the actuator tube 78, and therefore with the actuator 36. The driving pin 68 extends through openings or slots 84 (FIG. 4) in the support 26 (e.g., in the main tube 28 and insert 74) to connect to the actuator tube 78. The slots 84 allow the driving pin to move longitudinally along the longitudinal axis LA2 of the support as the object holder 34 moves between the release and grabbing configurations. The interaction of the slots 84 and the driving pin 68 also prevents the actuator tube 78, and thereby the actuator 36, from rotating relative to the support 26 about the longitudinal axis LA2.

Referring to FIGS. 1 and 2, the recess 32 of the support 26 remains uncovered regardless of if the actuator 36 is in its release or grabbing position. By keeping the recess 32 uncovered, the user does not have to worry about the middle finger disposed in the recess being uncomfortably squeezed, such as by the actuator or actuator tube. The upper end of the actuator tube 78 and the actuator 36 do not overlap or cover the recess 32 (e.g., any portion thereof) when the actuator is in its release position and grabbing position. In the illustrated embodiment, the upper end of the actuator tube 78 is shaped to match the contour (e.g., perimeter) of the recess 32. When the actuator 36 is in its release configuration, the upper end of the actuator tube 78 aligns with the lower end of the recess 32 (FIG. 2). This allows the actuator 36 to move moved closer to the first handle 12 without the actuator tube 78 covering a portion of the recess 32, then if the upper end of the tube was not contoured to match the shape of the recess (e.g., if the upper end of the tube was cut perpendicular to its length). This allows the user to create a more fist-like closed grip with the object grabber 10 when the user is pulling the actuator 36, providing greater comfort and control to the user.

Referring to FIGS. 1-5, movement of the actuator 36 (e.g., trigger 82) opens and closes the object holder 34. In operation, the actuator 36 is moved (e.g., pulled) by the finger (e.g., index finger) of the hand of the user grasping the first handle to move the object holder 34 between the release and grabbing configurations. As mentioned herein, in the illustrated embodiment, the actuator 36 (e.g., the trigger 82) is only pulled by the index finger of the hand of the user when the hand is grasping the first handle 12. To move the object holder 34 toward the release configuration, the actuator 36 is moved toward its release position. The actuator 36 is pulled upward, toward the first handle 12, by the finger (e.g., index finger) of the user. This moves (e.g., slides) the actuator tube 78 and the driving pin 68 upward, toward the first handle 12, as well. As the driving pin 68 moves upward, the driving pin moves along the slots 66 in the jaw drivers 54, 56. The slots 66 convert the linear movement of the driving pin 68 (broadly, actuator 36) into the pivoting movement of the jaws 46, 48. As the driving pin 68 travels upward within the slots 66, the jaw drivers 54, 56 are forced to pivot about the fourth pivot connection 62. This pivoting causes the first and second jaws 46, 48 to pivot about the first pivot connection 52 toward their respective release positions, thereby placing the object holder 34 in the release configuration. The pivoting of the jaw drivers 54, 56 about the fourth pivot connection 62 results in the lower ends of the jaw drivers 54, 56 moving laterally outward. This in turn moves the upper ends of the jaws 46, 48 (connected to the lower ends of the jaw drivers 54, 56 by the respective second and third pivot connections 58, 60) laterally outward as well. This in turn pivots the jaws 46, 48 about the first pivot connection 52, moving the tips of the jaws away from one another to place the object holder 34 in the release configuration. As the jaws 46, 48 move toward the release configuration, the shaft or fastener forming the first pivot connection 52 moves linearly (in an upward direction) along the longitudinal axis LA2 of the support 26 and the guide channels 76. The shaft or fastener forming the fourth pivot connection 52 is in a fixed longitudinal position relative to the support 26 and does not move relative to the longitudinal axis LA2 of the support. The user holds the actuator 36 in its release position as desired to keep the object holder 34 in the release configuration.

The shape of the slots 66 causes the first and second jaws 46, 48 to open extra wide when moving toward the release configuration. As the driving pin 68 moves along the slots 66, the driving pin moves first along the first segments 66A and then into and along the second segments 66B of the slots 66. The angle of the second segment 66B relative to the first segment 66A results in the driving pin 68 moving the lower ends of the jaw drivers 54, 56 laterally outward more to open the jaws 46, 48 wider.

To move the object holder 34 toward the grabbing configuration, the actuator 36 is moved toward its grabbing position. The user releases (broadly, actuates or operates) the actuator 36 to permit the actuator to move, via the closing springs 70. The user can quickly release the actuator 36 with the finger or gradually release the actuator for better control. As the actuator 36 is released, the closing springs 70 move the driving pin 68 downward, away from the first handle 12. This in turn moves (e.g., slides) the actuator tube 78 and the actuator 36 downward, away from the first handle 12, as well. As the driving pin 68 moves downward, the driving pin moves along the slots 66 in the jaw drivers 54, 56. As the driving pin 68 travels downward within the slots 66, the jaw drivers 54, 56 are forced to pivot in the opposite direction about the fourth pivot connection 62. This pivoting causes the first and second jaws 46, 48 to pivot in the opposite direction about the first pivot connection 52 toward their respective grabbing positions, thereby placing the object holder in the grabbing configuration. The pivoting of the jaw drivers 54, 56 about the fourth pivot connection 62 results in the lower ends of the jaw drivers moving laterally inward. This in turn moves the upper ends of the jaws 46, 48 laterally inward as well. This in turn pivots the jaws 46, 48 about the first pivot connection 52, moving the tips of the jaws toward one another to place the object holder in the grabbing configuration. As the jaws 46, 48 move toward the grabbing configuration, the shaft or fastener forming the first pivot connection 52 moves linearly (in a downward direction) along the longitudinal axis LA2 of the support 26 and the guide channels 76.

In other embodiments, the closing springs 70 can be omitted and the user manually moves the actuator to its grabbing position and holds the actuator in the its grabbing position to maintain the object holder 34 in its grabbing configuration.

The engagement between any number of components of the object grabber 10 can act as stops that position the object holder 34 in the release and grabbing configurations, and the actuator 36 in its corresponding release and grabbing positions. For example, the driving pin 68 can engage the opposite ends of the slots 84 of the support 26 to position the object holder 34 in its respective release and grabbing configurations, and the actuator 36 in its respective release and grabbing positions. Alternatively, or in addition, the driving pin 68 can engage the opposite ends of the slots 66 of the jaw drivers 54, 56 to position the object holder 34 in its respective release and grabbing configurations, and the actuator 36 in its respective release and grabbing positions. Stops of other configurations can be used without departing from the scope of the present disclosure.

Referring to FIGS. 1-8, the object grabber 10 includes a scale 90 for indicating a weight of the object held by the object holder 34. The scale 90 can be used to determine the weight of the object, such as a fish, after the object has been grabbed and secured by the object holder 34. In the illustrated embodiment, the scale 90 is a mechanical scale, rather than an electronic scale. The mechanical scale determines and indicates the weight of the object through mechanical components rather than electronic sensors, digital displays, and/or electricity. Although an electronic scale can be used without departing from the scope of the present disclosure.

The object grabber 10 of the present disclosure separates the grabbing and weighing functions to improve user experience for both operations. Conventional object grabbers that include weighing functionality (e.g., a mechanical scale) have one way of holding the device (e.g., one handle). In the case of holding a fish, this means that after the object grabber has grabbed the fish, the one handle being grasped by the user is moving (e.g., pulsing) relative to other components of the grabber (in order for the weighing function to indicate a weight) due to the weight and movement of the fish. This gives the user a sensation of not being in control because the fish moves relative to the one handle.

To separate the grabbing and weighing functions, the object grabber 10 of the present disclosure includes a second or weigh handle 92. The second handle 92 is distinct and separate from the first handle 12. The second handle 92 is configured to be grasped by the hand of the user. The object grabber 10 is configured for one-handed operation. It is envisioned that during use the user will grasp the object grabber 10 with one hand, the one hand grasping either the first handle 12 or the second handle 92. The user grasps just the first handle 12 when wanting to grab and manipulate (e.g., move) the object with the object holder 34. The user does not also need to grab the second handle 92 in this case. When grasping just the first handle 12, the scale 90 does not indicate the weight of the object. The user grasps just the second handle 92 when wanting to determine the weight of the object with the scale 90. The user does not also need to grab the first handle 12 in this case. In other methods of use, the user may grab the object grabber 10 with both hands, one grasping the first handle 12 and one grasping the second handle 92. Other configurations can be used without departing from the scope of the present disclosure.

The first handle 12 supports the object held by the object holder 34 without the weight of the object being indicated by the scale 90. The object holder 34, the first handle 12, and the scale 90 are arranged relative to one another such that the weight of the object being held by the object holder is not transferred by the scale between the object holder and the first handle. When the user grasps the first handle 12 to lift and control the object held by the object holder 34, the weight of the object is transferred directly from the object holder 34 to the handle 12 through the support 26, bypassing the scale 90. In other words, a load path from the object holder 34 to the first handle 12 that transfers the weight of the object being held to the first handle does not pass through (broadly, does not include) the scale 90 (specifically, the weigh spring). This configuration allows the user to maintain stable control of the object grabber 10 and the held object without experiencing the movement or pulsing that would occur if the scale 90 was used to transfer the weight of the object between the object holder and the first handle. The positions of the first handle 12 and the object holder 34 are fixed relative to one another and do not change.

The second handle 92 supports the object held by the object holder 34 with the weight of the object being indicated by the scale 90. When the user transitions from the grabbing function to the weighing function, the user releases the first handle 12 and grasps the second handle 92. In this configuration, the weight of the object held by the object holder 34 is transferred through the scale 90 mechanism. The object holder 34, the second handle 92, and the scale 90 are arranged relative to one another such that the weight of the object being held by the object holder is transferred by the scale between the object holder and the second handle. In other words, a load path from the object holder 34 to the second handle 12 that transfers the weight of the object being held to the second handle passes through (broadly, includes) the scale 90 (specifically, the weigh spring). The scale 90 provides the object's weight through the relative movement between components of the object grabber 10, allowing the user to read the weight measurement while supporting the object grabber 10 via the second handle 92. By separating the grabbing and weighing functions, the user only experiences the sensation of the object (e.g., fish) pulsing relative to their hand (e.g., second handle 92) when weighing the object. The moving or pulsing sensation is due to the distance between the object (e.g., the object holder) and the user's hand grasping the second handle 92 changing (due to components of the object grabber 10 moving relative to one another in order for the scale 90 to indicate the weight of the fish). The user does not experience this moving or pulsing sensation when grasping the first handle 12 to move/manipulate the object.

Referring to FIGS. 1, 2 and 6, the scale 90 includes scale indicia 94 for indicating the weight of the object being held by the object holder 34. In the illustrated embodiment, the scale indicia comprises a numeric weigh scale, such as an English (e.g., lb.) numeric weigh scale and/or a metric (e.g., kg.) numeric weighs scale. The numeric weigh scale has a plurality of weight markings for indicating different weights. Each weight marking can comprise a line and/or a numeral (e.g., 1, 1.5, 2, 2.5, 3, etc.) for indicating a particular weight. The weight markings of the scale indicia 94 are arranged in a sequence to provide a range of weight measurements that can be read by the user.

In the illustrated embodiment, the scale indicia 94 is disposed on the support 26, specifically on the main tube 28. The weight markings are arranged in sequence along the longitudinal axis LA1 of the support 26. In the illustrated embodiment, the weight marking indicating a zero weight (e.g., a zero weight marking) is at the lower end of the scale indicia 94 and the weight marking indicating the largest weight (e.g., a maximum weight marking) that can be determined by the scale 90 is at the upper end of the scale indicia. In the illustrated embodiment, the scale 90 includes two sets of scale indicia 94, one on each side of the support 26. To enable a user to view the scale indicia 94, the actuator tube 78 includes two viewing windows or openings 96 on opposite sides of the actuator 78. Each window 96 is aligned with a respective one of the sets of scale indicia 94 and allow the user to view the scale indicia. The windows 96 are sized and shaped to permit the user to view the scale indicia 94 when the actuator 36 (and actuator tube 78) is in both its release and grabbing positions.

The scale 90 also includes a weight indicator 98 for indicating or otherwise pointing to the weight markings of the scale indicia 94 to indicate the weight of the object. The weight indicator 98 and the scale indicia 94 are moveable relative to one another to indicate the weight of the object held by the object holder 34. The relative movement between the weight indicator 98 and the scale indicia 94 provides a visual indication of the object's weight. During the weighing function, the weight indicator 98 points to a specific weight marking (e.g., 5 lbs) of the scale indicia 94, thereby visually indicating to the user that the weight of the object it that of the value (e.g., 5 lbs) associated with that specific weight marking. Other configurations can be used without departing from the scope of the present disclosure.

In the illustrated embodiment, the second handle 92 forms the weight indicator 98 of the scale 90. In particular, the top or upper end of the second handle 92 forms the weight indicator 98. Whichever weight marking of the scale indicia 94 the upper end of the second handle 92 aligns with (e.g., horizontally aligns with) during the weighing function is the weight of the object being held. Other configurations of the weight indicator can be used without departing from the scope of the present disclosure. For example, separate weight indicator such as a transparent lens with a reference line the slides over the scale indicia 94 can be used. In this embodiment, the lens would move with the second handle 92.

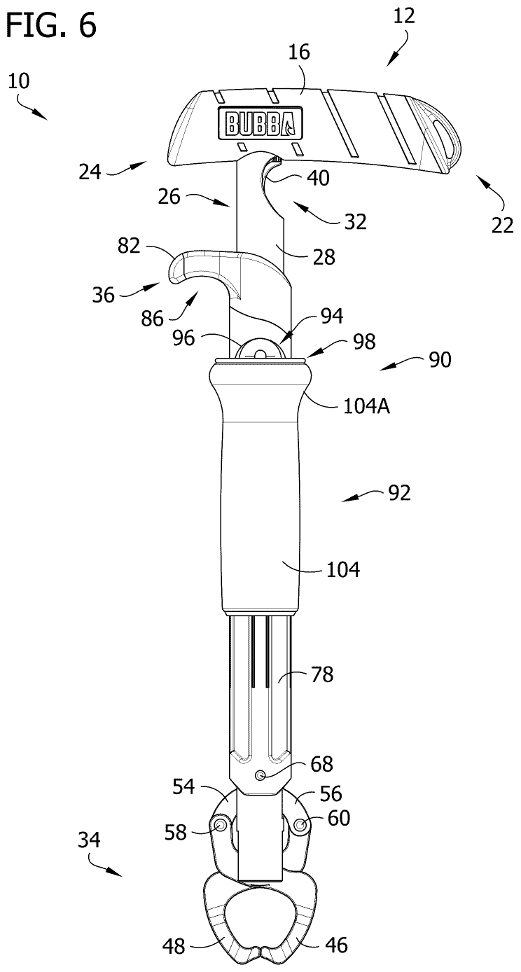

As is apparent, the second handle 92 is moveable relative to the support 26, the object holder 34, and the first handle 12. The second handle 92 moves along the support 26, in a direction parallel to the longitudinal axis LA2 thereof. The second handle 92 and the support 26 are moveable relative to one another to enable the scale 90 to indicate the weight of the object held by the object holder 34 (specifically, to move the top of the second handle 92 (broadly, the weight indicator 98) relative to the scale indicia 94 to indicate the weight). The second handle 92 is moveable between a first, at-rest, or zero weight position (FIGS. 1-5) and a plurality of second or weight indicating positions (one of which is shown in FIGS. 6-8). In the first position, the scale 90 indicates no weight (e.g., zero) is being held by the object holder 34. In other words, no object is being held by the object holder 34. The weight indicator 98 (e.g., upper end of the second handle 92) is aligned with the zero weight marking(s). In the second position, the scale 90 indicates a weight being held by the object holder. The weight indicator 98 (e.g., upper end of the second handle 92) is aligned with any one of the non-zero weight markings to indicate the weight of the object. It is understood the second position for the second handle 92 can be any position in which the scale 90 indicates a non-zero weight of the object (any position along the scale indicia 94 that is not the first position). Other configurations can be used without departing from the scope of the present disclosure.

The second handle 92 includes a handle support, body, or tube 100. The handle tube 100 slides linearly along the longitudinal axis LA2 of the support 26. The handle tube 100 slides longitudinally upward and downward along the main tube 28, and along the actuator tube 78. The handle tube 100 is disposed over the actuator tube 78, with the actuator tube 78 and the support 26 positioned within a bore or interior 102 of the handle tube. Both the actuator tube 78 and the support 26 (e.g., main tube 28) extend through the interior 102 of the handle tube 100, out the upper and lower ends thereof. The handle tube 100 moves longitudinally relative to the support 26 and actuator tube 78 so the scale 90 can indicate the weight of the object. The handle tube 100 can be made of metal, plastic, polymer, and/or any other suitable materials

The second handle 92 can includes a gripping material 104 overlying at least a portion of the handle tube 100. The gripping material 104 forms a grip for the second handle 92 to enable the user to better grasp the second handle. The gripping material 104 can be any suitable material which enhances the user's grip with the second handle, such as a polymer (e.g., an elastomer such that the gripping material is an elastomeric material). The gripping material 104 can be overmolded on the handle tube 100. In one embodiment, the gripping material 104 has a textured surface (e.g., ridges, bumps, recesses, depressions, and the like) for enhancing grip. In the illustrated embodiment, an upper portion 104A of the gripping material 104 has an inverted cone shape that extends laterally outward to enhance user grip of the second handle 92. When the user grasps the second handle 92, the upper portion 104A of the gripping material 104 can rest on the top of the user's hand (e.g., on the thumb, on the index finger, and on the Purlicue of the hand), making it easier for the hand to support the weight of the object grabber 10 and the object held thereby.

Referring to FIGS. 1-8, the first handle 12 is arranged such that the hand of the user grasps the first handle in a first orientation and the second handle 92 is arranged such that the hand of the user grasps the second handle in a second orientation different than the first orientation. The different orientations of the first and second handles 12, 92 provide distinct gripping configurations that are each optimized for their respective functions-grabbing and weighing. In the illustrated embodiment, the first and second orientations are about 90-degrees apart. The longitudinal axis LA1 (e.g., gripping axis) of the first handle 12 is generally perpendicular to a longitudinal axis (e.g., gripping axis) of the second handle 92 (which is coextensive with (more broadly, generally parallel to) the longitudinal axis LA2 of the support 26). With the object grabber 10 oriented such that the object holder 34 is arranged vertically below the first handle 12, as shown in the figures, the first handle is configured to orient the hand of the user such that a thumb of the hand of the user is on a lateral side of the hand when the hand is grasping the first handle. In other words, the user's hand is in a horizontal orientation (a rod being grasped by the user would extend generally horizontally when the user's hand is in the first orientation). When grasping the first handle 12, the thumb of the hand can extend over or wrap around the second end 24 of the first handle. With the object grabber 10 oriented such that the object holder 34 is arranged vertically below the first handle 12, as shown in the figures, the second handle 92 is configured to orient the hand of the user such that the thumb of the hand is on a top side of the hand when the hand is grasping the second handle. This perpendicular arrangement between the first and second handles 12, 92 allows each handle to provide an ergonomic grip position that is suited to its respective gripping and weighing functions. Other configurations can be used without departing from the scope of the present disclosure.

As shown in FIGS. 1, 2, and 6, the scale indicia 94 are positioned above the second handle 92. This arrangement (the scale indicia 94 being located above the location (e.g., second handle 92) at which the user holds the object grabber 10 during the weighing function) improves the user's ability to see and read the scale indicia (e.g., the weight markings). It reduces stress on the user when reading the scale indicia 94, improving the weighing experience. The user can see the scale indicia 94 above their hand when they are holding the object grabber 10 by the second handle 92. This reduces the height in which the user must elevate the object grabber 10 and object, over conventional devices where the scale indicia is below the holding or grasping location, during the weighing process.

Referring to FIGS. 3-5, 7, and 8, the scale 90 includes a weigh spring 106. The weigh spring 106 is disposed in the interior 30 of the main tube 28. The weigh spring 106 enables the object grabber 10 (specifically, the scale 90) to determine and indicate the weight of objects held by the object holder 34. In the illustrated embodiment, the weigh spring 106 comprises a compression spring. The weigh spring 106 responds to the weight of the object by compressing based on the gravitational force exerted by the object. Other spring configurations can be used without departing from the scope of the present disclosure. For example, the object grabber can be reconfigured to use a tension spring. In the illustrated embodiment, the weigh spring 106 is a coil spring. Extending through the weigh spring 106 is a link 108 (e.g., a spring force link). The link 108 moves longitudinally (up and down) relative to the main tube 28 when the scale 90 operates to indicate the weight of an object held by the object holder 34. The link 108 operatively connects the weigh spring 106 and the second handle 92 together. A first or upper end of the link 108 is connected to the second handle 92 by a pin or shaft 109. The pin 109 extends out the interior 30 through openings or slots 110 in the main tube 28 (broadly, support 26) and through the windows 96 of the actuator tube 78 to the second handle 92. The slots 110 are disposed on opposite sides of the main tube 28. In the illustrated embodiment, the scale indicia 94 (e.g., the weigh markings) is disposed along the slots 110. The pin 109 is moveable along the slots 110. The slots 110 allow the pin 109 (and thereby the second handle 92 and the link 108) and the support 26 to move relative to one another to indicate the weight. The interaction of the slots 110 and the pin 109 also prevents the second handle 92 from rotating relative to the support 26 about the longitudinal axis LA2.

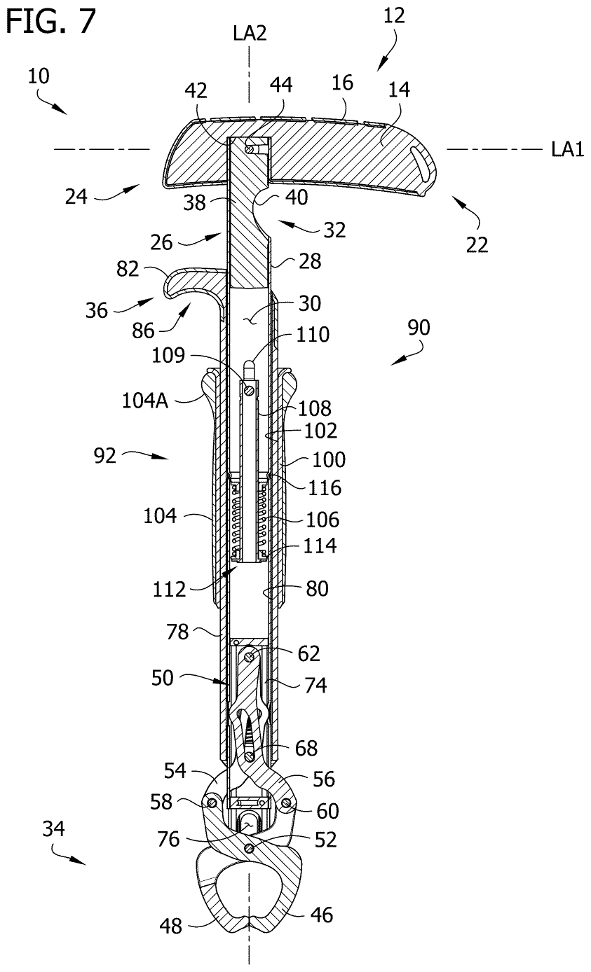

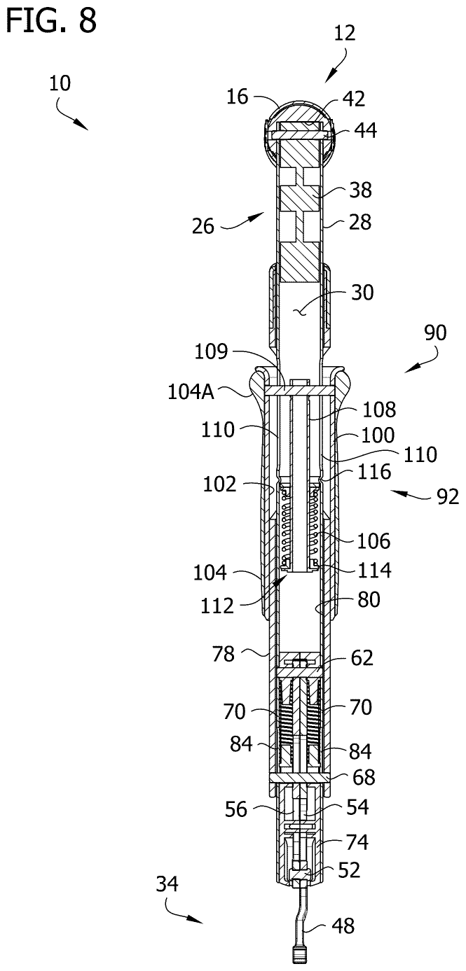

A second or lower end of the link 108 is biased toward the object holder 34 by the weigh spring 106. This biases the second handle 92 toward its first position (indicating no weight). In the illustrated embodiment, the engagement between the pin 109 and the lower end of the slots 110 (see FIG. 4) acts as a stop that positions the second handle 92 in its first position. Stops of other configurations can be used without departing from the scope of the present disclosure. The lower end of the link 108 includes a collar 112 having a flange 114 (broadly, shoulder). A second or lower end of the weigh spring 106 bears against the flange 114. The first or upper end of the weigh spring 106 bears against the support 26. In particular, the upper end of the weigh spring 106 bears against a keeper 116 of the main tube 28. The keeper 116 fixes the upper end of the weigh spring 106 in position relative to the support 26 (e.g., main tube 28), so that the upper end of the weigh spring cannot move relative to support along the longitudinal axis LA2. In the illustrated embodiment, the keeper 116 comprises a rolled feature formed in the main tube 28, although other configurations can be used without departing from the scope of the present disclosure. During weighing operations, the weigh spring 106 is compressed between the keeper 116 and the collar 112 (see FIGS. 7 and 8). In one embodiment, as illustrated, a plate or flange (broadly, cap) can be disposed between the upper end of the weigh spring and the keeper. The force (broadly, spring constant) of the weigh spring 106 and the scale indicia 94 correspond to one another such that the actual weight of the object that compresses the weigh spring corresponds to the weight indicated by the scale indicia. In one embodiment, the weigh spring 106 is not compressed or is negligibly compressed when the second handle 92 is in its first position. Other configurations can be used without departing from the scope of the present disclosure.

Referring to FIGS. 1-5, when no object is connected to the object holder 34 (no weight us being supported), the weigh spring 106 biases the second handle 92 downward toward the object holder, positioning the second handle in its first or at-rest position (regardless of if the object grabber 10 is being supported by the first handle 12 or the second handle). The weight indicator 98 formed by the upper end of the second handle 92 aligns with the zero weight marking of the scale indicia 94, indicating there is no weight on the object holder.

Referring to FIGS. 6-8, to use the scale 90 to determine the weight of the object (after the object is grabbed or attached to the object holder 34), the user releases the first handle 12 and grasps the second handle 92. The user can grasp the second handle 92 with one or both hands. The user supports the object grabber 10 with just the second handle 92. The user does not support the object grabber with the first handle 12 or any other component, thereby allowing the full weight of the object to be transferred to the scale 90 (specifically, the weigh spring 106) and supported by the second handle 92. The user orients the object grabber 10 so that the object (e.g., object holder 34) is disposed below the second handle 92. In other words, the object grabber 10 is oriented so that the longitudinal axis LA2 of the support 26 extends generally vertically, with the first handle 12 disposed above the object holder 34. The weight of the object is transferred to the support 26 (specifically, the main tube 28) through the connection between the support and the object holder 34. The gravitational force exerted by the object causes the support 26 to slide downward relative to the second handle 92. This downward movement of the support 26 occurs against the resistance of the weigh spring 106, which becomes compressed between the keeper 116 (which moves downward with the support) and the collar 112 (which is stationary because the user is holding the second handle 92) as the spring responds to the applied load.

The downward movement of the support 26 relative to the second handle 92 causes the scale indicia 94 disposed on the support to move downward as well (relative to the second handle). The movement continues until the weight of the object is balanced by the resulting spring force generated by the compression of the weigh spring 106. When this equilibrium is reached, the support 26 (and object and object holder 34) stops moving relative to the second handle 92, and the scale 90 provides a stable weight reading. The user reads the weight of the object by observing which weight marking of the scale indicia 94 aligns with the weight indicator 98 (e.g., the upper end of the second handle 92). The weight marking that aligns with the weight indicator 98 corresponds to the actual weight of the object being held by the object holder 34, providing the user with the weight measurement.

It is appreciated that the person of ordinary skill in the art is readily able to determine the scope of terms of degree such as, but not limited to, “about,” “substantially,” and “generally.” For example, when a term of degree is used in relation to a numeric value, the person of ordinary skill in the art understands that the term of degree covers an inclusive range of plus or minus 10% of the numeric value, unless clearly indicated or stated otherwise.

When introducing elements of the present disclosure or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

Modifications and variations of the disclosed embodiments are possible without departing from the scope of the disclosure defined in the appended claims. For example, where specific dimensions are given, it will be understood that they are examples only and other dimensions are possible. As various changes could be made in the above constructions, products, and methods without departing from the scope of the disclosure, it is intended that all matter contained in the above description and shown in the accompanying drawings shall be interpreted as illustrative and not in a limiting sense.

What is claimed is:

1. An object grabber for grabbing an object, the object grabber comprising:
a first handle configured to be grasped by a hand of a user;
a second handle configured to be grasped by the hand of the user;
an object holder moveable between a release configuration to release the object and a grabbing configuration to grab the object;
an actuator operatively connected to the object holder to move the object holder between the release and grabbing configurations; and
a scale configured to indicate a weight of the object held by the object holder.

2. The object grabber of claim 1, wherein the scale comprises a mechanical scale.

3. The object grabber of claim 2, wherein the mechanical scale comprises a weigh spring.

4. The object grabber of claim 1, wherein the scale includes a weight indicator and scale indicia having a plurality of weight indicators for indicating different weights, the weight indicator and the scale indicia being moveable relative to one another to indicate the weight of the object held by the object holder.

5. The object grabber of claim 4, wherein the second handle includes the weight indicator of the scale.

6. The object grabber of claim 5, wherein the second handle is moveable relative to the first handle.

7. The object grabber of claim 1, wherein the first handle is farther than the second handle from the object holder.

8. The object grabber of claim 1, wherein the first handle is configured to define a first gripping orientation of the user's hand relative to the object grabber, and the second handle is configured to define a second gripping orientation of the user's hand relative to the object grabber different form the first gripping orientation.

9. The object grabber of claim 1, wherein, with the object grabber oriented such that the object holder is arranged vertically below the first handle, the first handle is configured to orient the hand of the user such that a thumb of the hand of the user is on a lateral side of the hand when the hand is grasping the first handle and the second handle is configured to orient the hand of the user such that the thumb of the hand is on a top side of the hand when the hand is grasping the second handle.

10. The object grabber of claim 1, wherein the object holder, the first handle, and the scale are arranged relative to one another such that the weight of the object being held by the object holder is not transferred by the scale between the object holder and the first handle.

11. The object grabber of claim 10, wherein the object holder, the second handle, and the scale are arranged relative to one another such that the weight of the object being held by the object holder is transferred by the scale between the object holder and the second handle.

12. The object grabber of claim 1, wherein the first handle is configured to support the object held by the object holder without the weight of the object being indicated by the scale.

13. The object grabber of claim 12, wherein the second handle is configured to support the object held by the object holder with the weight of the object being indicated by the scale.

14. The object grabber of claim 1, further comprising a support extending between the first handle and the object holder.

15. The object grabber of claim 14, wherein the actuator is moveable relative to the support to move the object holder between the release and grabbing configurations.

16. The object grabber of claim 14, wherein the support and the second handle are moveable relative to one another to enable the scale to indicate the weight of the object held by the object holder.

17. The object grabber of claim 14, wherein the scale includes scale indicia on the support.

18. The object grabber of claim 1, wherein the actuator is moveable relative to the first handle and relative to the second handle.

19. The object grabber of claim 1, wherein the actuator is arranged relative to the first handle to be actuated by the hand of the user when the hand is grasping the first handle.

20. The object grabber of claim 1, wherein the object holder comprises first and second jaws, at least one of the first or second jaw being configured to move relative to the other of the first or second jaw when the object holder is moved between the release and grabbing configurations.
